(19) United States
(12) Patent Application Publication
(10) Pub. No.: US 2026/0202535 A1
(43) Pub. Date: Jul. 16, 2026

(54) A WHEEL AXLE MOUNTED VEHICLE GROUND RADAR SYSTEM

(71) Applicant: VOLVO TRUCK CORPORATION, Götebong (SE)

(72) Inventor: Johan LINDBERG, Götebong (SE)

(73) Assignee: VOLVO TRUCK CORPORATION, Götebong (SE)

(21) Appl. No.: 19/133,075

(22) PCT Filed: Nov. 28, 2022
(86) PCT No.: PCT/EP2022/083544

§ 371 Date: May 27, 2025

(51) Int. Cl. G01S 13/58; G01S 7/00; G01S 7/02

(52) U.S. Cl. CPC G01S 13/58; G01S 7/006; G01S 7/027

(57) ABSTRACT

A radar sensor system has a radar sensor arranged to be mounted onto a rotatable wheel axle of a heavy-duty vehicle, where the radar sensor is arranged to generate a distance data sequence during rotation of the wheel axle, and a control system arranged to receive the distance data sequence from the radar sensor and to determine a distance between the wheel axle and a road surface supporting the heavy-duty vehicle, normal to the road surface, based on the distance data sequence.

### TECHNICAL FIELD

This disclosure relates generally to sensors and systems for control of heavy-duty vehicles such as trucks, busses, and construction equipment. In particular aspects, the disclosure relates to radar sensors mounted directly onto a wheel axle of the vehicle. Although the disclosure may be described with respect to a particular vehicle, the disclosure is not restricted to any particular vehicle.

### BACKGROUND

Modern heavy-duty vehicles often comprise advanced vehicle motion management (VMM) systems that manage control of the different actuators of the vehicle, such as propulsion devices, steering arrangements, and braking devices, to obtain a desired vehicle motion in a safe and power conserving manner. To do this dependably and efficiently, the vehicle control systems need accurate and reliable data upon which control decisions can be based.

There is a general desire to improve the quality of the data available for vehicle motion management involving heavy-duty vehicles. There is also a desire to provide redundant methods for obtaining vehicle motion state data.

### SUMMARY

There is disclosed herein a radar sensor system comprising a radar sensor arranged to be mounted onto a rotatable wheel axle of a heavy-duty vehicle. The radar sensor is arranged to generate a distance data sequence during rotation of the wheel axle. The system also comprises a control system arranged to receive the distance data sequence from the radar sensor and to determine a distance between the wheel axle and a road surface supporting the heavy-duty vehicle, normal to the road surface, based on the distance data sequence. The radar sensor is preferably mounted onto the rotatable wheel axle in connection to an aperture or a radome section formed in a wheel axle housing of the rotatable wheel axle.

Aspects of the disclosure may seek to provide more accurate data regarding tyre dimensions associated with one or more wheels of the heavy-duty vehicle. It is an advantage that the distance data is with reference to the wheel axle, since then the distance from the vehicle to ground is not as affected by the suspension of the vehicle as it is if distance data is obtained from a position on the chassis or cab of the heavy-duty vehicle.

In some examples, the control system is arranged to determine a loaded tyre radius and/or an effective rolling radius of a wheel of the heavy-duty vehicle based on the determined distance between the wheel axle and the road surface. Obtaining accurate information regarding the loaded tyre radius is not always easy since many parameters influence it. It is therefore an advantage that the radar sensor system is able to directly measure the loaded tyre radius. The measurement data is obtained with very low latency and therefore changes more or less instantaneously if the load on the tyre changes or if some other tyre property such as inflation pressure changes abruptly.

The radar sensor system may also comprise at least two radar sensors arranged spatially separated on the rotatable wheel axle, e.g., on the left-hand side and on the right-hand side of the wheel axle. The control system can then be arranged to receive distance data sequences from the spatially separated radar sensors and to determine respective distances between the wheel axle and the road surface for each radar sensor based on the distance data sequences. This sensor set-up allows the control system to determine a roll motion of the heavy-duty vehicle based on the determined distances, which is an advantage.

According to some examples, the radar sensor system comprises at least two radar sensors arranged spatially separated on different rotatable wheel axles. The control system may then be arranged to receive distance data sequences from the radar sensors on the different rotatable wheel axles and to determine respective distances between the wheel axle and the road surface for each radar sensor based on the distance data sequences. The control system may also be arranged to determine a pitch motion of the heavy-duty vehicle based on the determined distances, which is an advantage.

According to some other examples, the control system is arranged to determine the distance between the wheel axle and the road surface supporting the heavy-duty vehicle, normal to the road surface, by identifying a distance corresponding to a local minimum of the distance data sequence. This method of identifying the distance between the wheel axle and the road surface using a sensor on a rotating axle means that there is no need for a calibration of sensor alignment, as would otherwise had been necessary. The sensor set-up is also relatively robust since a change in alignment does not matter so much, as it would only change the location of the minimum.

The radar sensor system may also comprise a rotational encoder arranged to output an angular position of the wheel axle. The control system can then be arranged to receive the angular position of the wheel axle from the rotational encoder, and to process the distance data sequence based on the angular position of the wheel axle. This technique can be used as a complement to finding the local minimum, or as an alternative.

According to examples, the control system is arranged to determine the distance between the wheel axle and the road surface supporting the heavy-duty vehicle, normal to the road surface, based on a weighted combination of elements in the distance data sequence. This is an advantage, e.g., if the distance data sequence comprises data from more than one radar sensor. The distance data sequence may also comprise data from other sensor types, such as ultrasonic sensors. A more robust measurement of distance can be obtained in this manner.

The radar sensor or sensors of the radar system may be powered by an inductive power transfer arrangement and/or a capacitive power transfer arrangement and/or by an electric brush arrangement. Thus, there are several ways to power the arrangement, which can be used separately or in combination for redundancy purposes.

The radar sensor can be arranged to transmit the distance data sequence as a wireless signal to a receiver communicatively coupled to the control system. This brings the added benefit of reducing the number of cables from the radar sensor to the control system. It is, however, noted that a wired connection is also possible, using brushes or the like which contact conductors arranged on the wheel axle.

According to some examples the radar sensor is arranged to generate a longitudinal speed data sequence during rotation of the wheel axle. The control system can then be arranged to receive the longitudinal speed data sequence from the radar sensor and to determine a longitudinal velocity of the vehicle relative to the road surface based on the longitudinal speed data sequence, which is an advantage. A lateral speed data sequence may be generated in the same manner.

As for the determining of the distance sequence, the control system may be arranged to determine the longitudinal velocity and/or the lateral velocity of the vehicle relative to the road surface based on a weighted combination of elements in the speed data sequence. This increases the robustness and accuracy of the velocity estimate, which is an advantage.

The radar sensor system may also comprise fins or other protrusions attached to the wheel axle and configured to generate a flow of air in connection to the radar sensor. This flow of air prevents dirt and ice from accumulating around the radar sensor, which is an advantage.

The radar sensor system can also be arranged to determine a rotation speed of the wheel axle based on the distance data sequence. Thus, remarkably, aspects of the radar sensor system are capable of determining tyre radius, vehicle speed over ground, and wheel speed—all the components required for computing wheel slip. Both longitudinal and lateral wheel slip may be determined.

According to some examples, the radar sensor is arranged to generate a distance data sequence also when the wheel axle is stationary. This distance data can, e.g., be used to determine tyre radius during loading of the vehicle, which is an advantage since the loaded tyre radius in turn can be used to determine when a maximum load has been placed on the vehicle.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein vehicles, control units, computer systems, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1 illustrates an example heavy-duty vehicle,

FIGS. 2A-B schematically illustrate example wheel axles comprising radar sensors,

FIG. 3 schematically illustrates a vehicle actuator and control system,

FIG. 4 schematically illustrates an example wheel axle comprising radar sensors,

FIG. 5 schematically illustrates a vehicle actuator and control system,

FIG. 6 is a graph illustrated detected range as function and axle rotation,

FIG. 7 illustrates a range/distance sensing technique,

FIG. 8 is a flow chart illustrating methods, and

FIG. 9 is a schematic diagram of an exemplary computer system.

### DETAILED DESCRIPTION

The present disclosure will now be described more fully hereinafter with reference to the accompanying drawings, in which exemplary embodiments are shown. The disclosure may, however, be embodied in many different forms and should not be construed as limited to the embodiments set forth herein; rather, these embodiments are provided for thoroughness and completeness. Like reference character refer to like elements throughout the description. Aspects set forth below represent the necessary information to enable those skilled in the art to practice the disclosure.

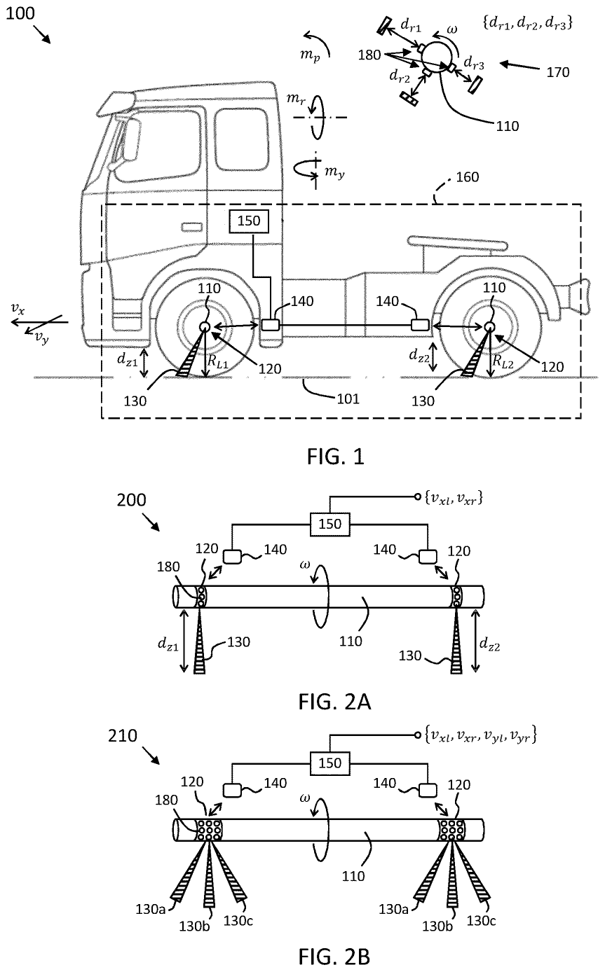

FIG. 1 illustrates an example heavy-duty vehicle 100, here in the form of a truck arranged to tow one or more trailer units. The vehicle is associated with a longitudinal direction x which extends in the intended direction of travel of the vehicle orthogonal to the wheel axles (110) of the vehicle, and a lateral direction y which is parallel with the wheel axles (110) of the vehicle and thus orthogonal to the longitudinal direction x. The longitudinal velocity of the vehicle 100 is denoted vₓ and the lateral velocity is denoted v_{y} as illustrated in FIG. 1. The vehicle 100 may have arbitrary motion comprising pitch motion mₚ, roll motion mᵣ, and/or yaw motion m_{y}, as illustrated in FIG. 1.

Heavy-duty vehicles have traditionally been controlled using torque request signals generated based on the position of an accelerator or brake pedal and sent to motion support devices (MSDs) such as service brakes and propulsion devices over digital interfaces. However, advantages may be obtained by instead controlling the actuators using wheel slip or wheel speed requests sent from a central vehicle controller to the different actuators. This moves the actuator control closer to the wheel end, and therefore allows for a reduced latency and a faster more accurate control of the MSDs. Wheel-slip based MSD control approaches are particularly suitable for use with wheel-end electrical machines in a battery or fuel cell powered heavy-duty vehicle, which axle speeds can be accurately controlled at high bandwidth. Wheel-slip based vehicle motion management (VMM) and its associated advantages are discussed, e.g., in WO 2017/215751 and also in WO 2021/144010.

Heavy-duty vehicle control, in particular control based on wheel slip and wheel speed, rely on accurate knowledge of the vehicle speed over ground as well as the rotation speed of the wheels and the radii of the wheels, since these three quantities together determine the wheel slip. Longitudinal wheel slip λₓ may, in accordance with SAE J670 (SAE Vehicle Dynamics Standards Committee Jan. 24, 2008) be defined as

$${λ}_{x} = \frac{{R}_{E} ω - {v}_{x}}{max ( \vert {R}_{E} ω \vert , \vert {v}_{x} \vert )}$$

where R_{E} is an effective tyre rolling radius in meters, a is the angular velocity of the wheel, and vₓ is the longitudinal speed of the wheel (in the coordinate system of the wheel). Thus, λₓ is bounded between −1 and 1 and quantifies how much the wheel is slipping with respect to the road surface. Wheel slip is, in essence, a speed difference measured between the wheel and the vehicle.

A wheel has an unloaded tyre radius R_{U} and a loaded tyre radius R_{L}, where the loaded tyre radius R_{L} is generally smaller than the unloaded tyre radius R_{U}. The unloaded tyre radius may vary some in dependence of tyre nominal inflation pressure, temperature, and other tyre properties, but it is normally possible to determine it at least approximately in a reliable manner from tyre specification alone, although tyre wear does have an effect which can be hard to determine without manual inspection. The loaded tyre radius R_{L} is much more difficult to determine, at least with low latency, since it depends on the weight of the vehicle, i.e., the normal force F_{Z} acting on the tyre and also on the temperature of the tyre (which affects both tyre material properties and tyre inflation pressure). The effective rolling radius R_{E} of the wheel 102 is somewhere inbetween the unloaded and the loaded tyre radius. Knowing the loaded and the unloaded tyre radius, it is often possible to determine the effective tyre rolling radius R_{E} using, e.g., a look-up table or the like which can be pre-configured by the vehicle. The effective rolling radius R_{E} can also be determined based on a travelled distance by the vehicle and on a number of wheel rotations during the travel. However, such methods involve relatively high latency and are not effective for detecting fast changes in effective rolling radius, as occur, e.g., when the vehicle is loaded or when tyre pressure is adjusted.

The rotation speed of the wheel ω can be obtained in a reliable manner from sensors such as Hall effect sensors or rotary encoders. However, the vehicle speed over ground vₓ may be more difficult to obtain robustly and in a cost-efficient manner, at least in some challenging environments and operating conditions, such as low friction operating conditions and during maneuvering involving large wheel forces. A global positioning system (GPS) receiver is often able to determine vehicle speed over ground, but satellite systems are prone to error in environments with strong multipath radio propagation and of course require a clear view of the sky to operate, which is not always available. Advanced radar systems and vision-based sensor can also be used to determine vehicle speed over ground, but these sensors may be costly and may also be prone to error due to, e.g., sun glare and interference from nearby transmitters. US 2004/0138802 discusses use of radar techniques for determining vehicle speed over ground. However, there is a continuing need for reliable and cost-effective methods of determining vehicle speed over ground suitable for use in heavy-duty vehicles controlled based on wheel slip. US 2006/0139206 also discusses use of radar directed at the road surface for determining speed over ground.

The heavy-duty vehicle 100 illustrated in FIG. 1 is equipped with a radar sensor system 160 which comprises one or more radar sensors 120 mounted directly onto the wheel axles 110 of the vehicle 100. Each such radar sensor 120 illuminates the underside of the vehicle chassis and parts of the road surface by one or more transmission lobes 130 which rotate with the wheel axle 110.

With reference to the insert 170 in FIG. 1, a number of radar transceiver antennas 180 comprised in the radar sensor 120 have been attached to a wheel axle 110, which rotates with an angular velocity ω. The radar antennas transmit and receive radar signals from which a number of distances {dᵣ₁, dᵣ₂, dᵣ₃}can be determined, and the distance measurements are then repeated at some frequency as the wheel axle rotates. The radar sensor 120 mounted onto the wheel axle 110 may comprise one or more radar antennas 180 and one or more radar transceivers. A single radar antenna will provide a sequence of measured distances which repeats with every rotation of the wheel axle. A radar system with more than one radar antenna will produce a sequence of measured distances with higher rate.

Each radar antenna will at some point during the rotation of the wheel axle face the road surface 101. Thus, the one or more radar sensors 120 collect at least distance data indicative of the distance from the wheel axle 110 to ground. The radar sensor preferably also generates speed data indicative of a speed of the vehicle 100 over the road surface 101 supporting the vehicle 100. Also, since the measured data repeats with a frequency corresponding to the angular velocity ω of the wheel axle, the output data from the radar sensor 120 is also indicative of the angular velocity ω. In other words, since the angular velocity ω has an impact on the periodicity of the distance data obtained from the radar sensor, it is possible to determine the angular velocity from the distance data using a frequency analysis or time correlation of the distance data.

The data from the radar sensor 120 is communicated to a data receiver 140 (preferably using a low power wireless link) and subsequently passed on to a control system 150 of the vehicle 100 arranged to process the distance data and/or the speed data from the one or more radar sensors 120. Thus, according to some aspects, the radar sensor 120 is arranged to transmit the distance data sequence as a wireless signal to a receiver 140 communicatively coupled to the control system 150.

Since the radar sensors are mounted onto the wheel axles, the distance data is not affected by the suspension of the vehicle. This is an advantage since the distance data can be used to infer loaded tyre radius in a more straight forward manner compared to if the radar sensor would have been mounted onto, e.g., the cab of the vehicle. Also, since the radar sensors rotate with the axle, they intermittently illuminate the road surface at an angle, which allows the vehicle speed over ground to be determined.

By monitoring two or more distances d_{z1}, d_{z2} between wheel axles and road surface at two or more locations with spatial separation, the pitch and/or the roll state of the vehicle 100 can be determined. To determine the pitch, the radar sensors need to be separated in the longitudinal direction, while lateral separation is required to determine roll in an accurate manner. By placing two or more radar sensors on each of two or more different wheel axles, both pitch and roll can be determined in a straight-forward manner by monitoring the distances from the radar sensors to ground.

To summarize, with reference also to FIGS. 2A, 2B, and 4, there is disclosed herein a radar sensor system 160, 200, 210, 400 comprising a radar sensor 120 arranged to be mounted onto a rotatable wheel axle 110 of a heavy-duty vehicle 100. The radar sensor 120 is arranged to generate a distance data sequence during rotation of the wheel axle 110 by transmitting a radar signal, receiving backscatter from this transmission, and processing the received backscatter from the transmitted radar signal to generate the distance data sequence. The radar sensor system also comprises a control system 150 arranged to receive the distance data sequence from the radar sensor 120 and to determine a distance d_{z} between the wheel axle 110 and a road surface 101 supporting the heavy-duty vehicle 100, normal to the road surface, based on the distance data sequence.

The radar sensor 120 may of course also generate a distance data sequence when the wheel axle 110 is stationary, i.e., not during rotation of the wheel axle. This distance data sequence can be used to determine a loaded tyre radius. The loaded tyre radius may for instance be determined by using an angular position a of the axle 110 and basic trigonometric relationships as illustrated in FIG. 7 on the right.

The radar sensor 120 may advantageously be combined with one or more ultrasound sensors, which are also capable of measuring range from the wheel axle to the ground.

An advantage of mounting the radar sensor system rotatably in this way is that alignment and calibration of transmission angle relative to the road surface is no longer necessary. The radar sensor rotates cross all angles, and the signal processing instead handles detection of suitable angle.

The radar sensor can, for instance, be realized using the radio stripe devices described in US2022123790. These are integrated antenna systems comprising antennas and processing circuitry which would be suitable for high carrier frequency radar operation. The “stripes” can be attached to the wheel axle along its circumference as illustrated in FIGS. 2A and 2B. FIG. 2A illustrates an example where each radar sensor 120 comprises a single row of radar transceiver antennas 180. These radar antennas allow determination of the distance to ground, and also determination of the vehicle speed over ground in the longitudinal direction as will be explained in more detail below. By correlating the distance data output from the radar sensors, the wheel angular velocity can also be determined. Thus, using a single radar sensor system, wheel slip λₓ can be determined by the control system 150, which is an advantage.

The radar sensor system may generally comprise one or more radar transceivers arranged to transmit respective radar signals over a radar bandwidth, where a larger bandwidth improves range resolution in a known manner. Velocity resolution depends on the radar wavelength and the repetition period of the waveform in a known manner. According to some aspects, the transceiver is arranged to transmit a frequency modulated continuous wave (FMCW) radar signal over the radar bandwidth, where a frequency chirp is swept over the radar bandwidth in cycles. Other types of radar signal formats may also be used, such as band-spread radar signals where orthogonal codes are used to spread a modulated signal over a wide frequency band, or an orthogonal frequency division multiplexed (OFDM) radar signal. Given an FMCW radar signal format, the distance to the ground plane (and also to reflecting material under the road surface) may be determined based on a first Discrete Fourier Transform (DFT), or Fast Fourier Transform (FFT), and the radial velocity or Doppler frequency of the illuminated portion of ground may be determined based on a second DFT or FFT, in a known manner. The result of applying a range FFT and a Doppler FFT is often denoted a range-Doppler map or R-D map for short. A range-Doppler map is a matrix of complex values, where each column index corresponds to backscatter energy received at a given radar antenna from reflections at a given range, and where each row index corresponds to radar backscatter energy received at a given radar antenna from reflections at a given radial velocity relative to the position of the radar transceiver. A good overview of rudimentary FMCW radar processing is given in the lecture notes “Introduction to mmwave Sensing: FMCW Radars” by Sandeep Rao, Texas Instruments, 2017. The Doppler frequency at the range corresponding to the distance between the radar transceiver and ground is indicative of the radial speed at which the ground moves relative to the radar transceiver, as explained in US 2004/0138802.

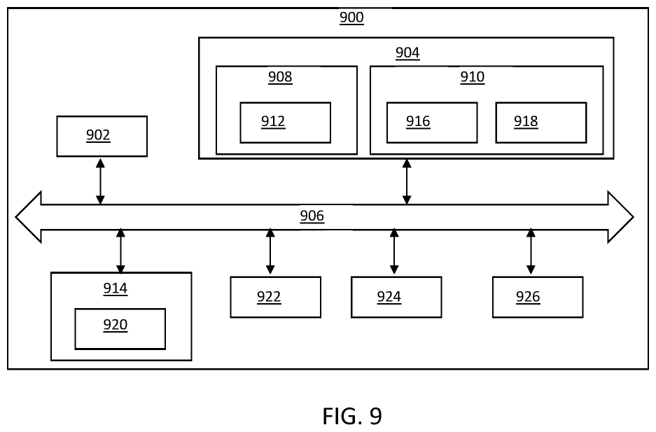

The data receiver 140 as well as the control system 150 of the vehicle 100 may include a microprocessor, microcontroller, programmable digital signal processor or another programmable device. The systems may also, or instead, include an application specific integrated circuit, a programmable gate array or programmable array logic, a programmable logic device, or a digital signal processor. Where the system(s) include(s) a programmable device such as the microprocessor, microcontroller or programmable digital signal processor mentioned above, the processor may further include computer executable code that controls operation of the programmable device. Implementation aspects of the different vehicle unit processing circuits will be discussed in more detail below in connection to FIG. 9.

The radar sensor system 210 illustrated in FIG. 2B comprises radar sensors with radar transceiver antennas that have been separated also in the lateral direction to form an antenna array capable of directing transmission lobes 130a, 130b, 130c in a lateral direction. This means that lateral motion by the vehicle can be detected using the output from the radar system, which is an advantage.

To summarize, according to some aspects, the radar sensor 120 is arranged to generate a longitudinal speed data sequence during rotation of the wheel axle 110, and the control system 150 is arranged to receive the longitudinal speed data sequence from the radar sensor 120 and to determine a longitudinal velocity vₓ of the vehicle 100 relative to the road surface 101 based on the longitudinal speed data sequence.

According to some other aspects, the radar sensor 120 is arranged to generate a lateral speed data sequence during rotation of the wheel axle 110, and the control system 150 is arranged to receive the lateral speed data sequence from the radar sensor 120 and to determine a lateral velocity v_{y} of the vehicle 100 relative to the road surface 101 based on the lateral speed data sequence.

The control system 150 can be arranged to determine a loaded tyre radius R_{L} and/or an effective rolling radius R_{E} of a wheel of the heavy-duty vehicle 100 based on the determined distance d_{z} between the wheel axle 110 and the road surface 101. This can be done using a preconfigured look-up table or the like which relates loaded and/or effective tyre radius to the measured distance from the radar sensor to the road surface. This look-up table can be determined from vehicle geometry and/or populated during operation of the vehicle. One example of such real-time updating of the relationship between the distance data from the radar sensor and the tyre radius properties is if a GPS-based system or the like is used to determine effective rolling radius using travelled distance in combination with a counter that keeps track of the number of wheel rotations during the travel, and then maps the distance data from the radar sensor to the determined effective rolling radius. One can of course also manually measure the loaded tyre radius and populate the look-up table based on the output from the radar system.

The control system 150 can also, as mentioned above, be arranged to determine the rotation speed ω of the wheel axle 110 based on the distance data sequence. This can be done by determining an autocorrelation function of the distance data sequence, which will indicate the repetition interval of the data in the distance data sequence. As mentioned above, the distance data in the distance data sequence will repeat for each revolution of the wheel axle, since the reflecting surfaces generating the distance data will remain more or less constant over time, at least for a shorter time period of seconds or minutes.

According to some aspects the radar sensor system 160, 200, 210, 400 comprises at least two radar sensors 120 arranged spatially separated on the rotatable wheel axle 110, as shown, e.g., in FIGS. 2A and 2B. The control system 150 can then be arranged to receive distance data sequences from the radar sensors 120 and to determine respective distances d_{z1}, d_{z2} between the wheel axle 110 and the road surface 101 for each radar sensor 120 based on the distance data sequences. Using these measurements of distance between the different radar sensors and the ground surface 101, the control system 150 may determine a roll motion mᵣ of the heavy-duty vehicle 100 based on the determined distances d_{z1}, d_{z2}. This determination can be performed by observing changes in the determined distances d_{z1}, d_{z2} over time, using a model of vehicle motion. Methods for estimating roll motion of a heavy-duty vehicle based on changes in distance from the vehicle chassis to the road surface are generally known and will therefore not be discussed in more detail herein.

In case the radar sensor system 160 comprises at least two radar sensors 120 arranged spatially separated on different rotatable wheel axles 110, as illustrated in FIG. 1, then the control system 150 can be arranged to receive distance data sequences from the radar sensors 120 and to determine respective distances d_{z1}, d_{z2} between the wheel axle 110 and the road surface 101 for each radar sensor 120 based on the distance data sequences. The control system 150 may then determine a pitch motion mₚ of the heavy-duty vehicle 100 based on the determined distances d_{z1}, d_{z2}. Methods for estimating pitch motion of a heavy-duty vehicle based on changes in distance from the vehicle chassis to the road surface are also generally known and will therefore not be discussed in more detail herein.

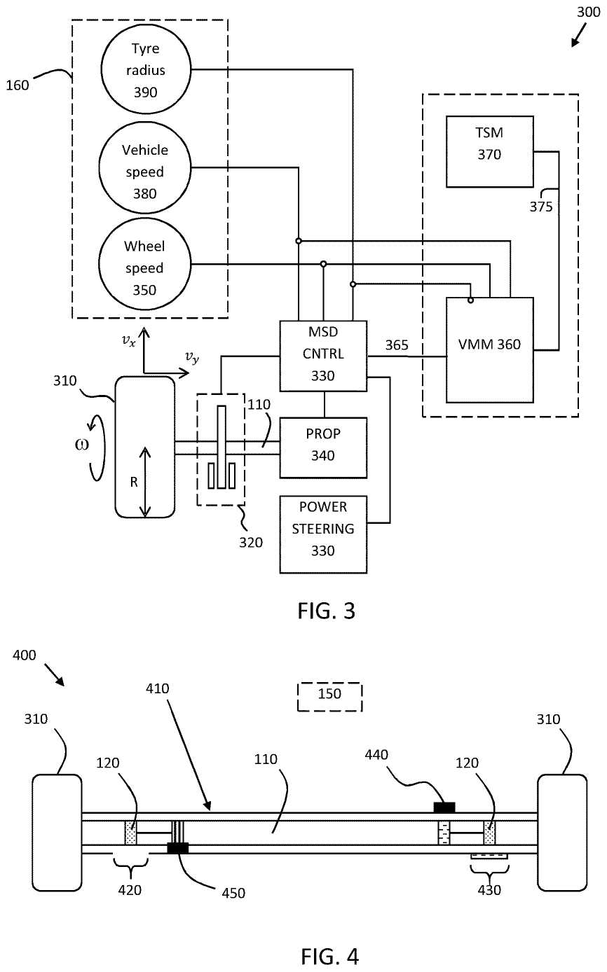

FIG. 3 schematically illustrates functionality 300 for controlling an example wheel 310 on the vehicle 100 by some example motion support devices (MSDs) here comprising a friction brake 320 (such as a disc brake or a drum brake), a propulsion device 340 and a power steering arrangement 330. The friction brake 320 and the propulsion device are examples of wheel torque generating devices, which can be controlled by one or more motion support device control units 330. The control is based at least in part on one or more data outputs from the radar sensor systems 160 discussed above, i.e., wheel speed data 350, vehicle speed data 380, and tyre radius data 390. An MSD control system 330 may be arranged to control one or more actuators.

A traffic situation management (TSM) function 370 plans driving operation with a time horizon of 10 seconds or so. This time frame corresponds to, e.g., the time it takes for the vehicle 100 to negotiate a curve or the like. The vehicle maneuvers, planned and executed by the TSM function, can be associated with acceleration profiles and curvature profiles which describe a desired target vehicle velocity in the vehicle forward direction and turning to be maintained for a given maneuver. The TSM function continuously requests the desired acceleration profiles a_{req} and steering angles (or curvature profiles c_{req}) from the VMM system 360 which performs force allocation to meet the requests from the TSM function in a safe and robust manner. The VMM system 360 operates on a timescale of below one second or so and will be discussed in more detail below.

The wheel 310 has a longitudinal velocity component vₓ and a lateral velocity component v_{y} (in the coordinate system of the wheel or in the coordinate system of the vehicle, depending on implementation). The wheel has a rotational velocity ω, and a tyre radius R (given as a loaded tyre radius and/or as an effective rolling radius).

A vehicle speed sensor 380 based on the herein disclosed radar systems can be used to determine vehicle speed over ground, which can then be translated into wheel speed components vₓ and/or v_{y}, in the coordinate system of the wheel. This means that the wheel steering angle δ is taken into account if the wheel is a steered wheel, while a non-steered wheel has a longitudinal velocity component which is the same as the vehicle unit to which the wheel is attached.

The wheel end module optionally comprises an electric machine 340, or at least a control unit for controlling an electric machine. The processing device 440 can then be arranged to control an axle speed of the electric machine 340 based on a target wheel slip k. This integrates both wheel slip determination and wheel slip control into a single wheel end module which can be mounted close to the wheel of a heavy-duty vehicle, where it can facilitate high bandwidth, i.e., rapid, wheel slip control. Further advantages are obtained of the wheel end module also comprises an inertial measurement unit (IMU), in which case the processing device 440 can be arranged to output one or more acceleration values to the central VMM system 360. This means that the VMM system 360 can obtain both accelerations, speeds over ground, and wheel slip from the wheel end module, allowing the VMM system close to full data about the current motion of the heavy-duty vehicle 100 in a dependable and cost-efficient manner.

FIG. 4 illustrates some optional aspects of a radar sensor system 400. The wheel axle is here covered by a wheel axle housing, which is commonly seen on many heavy-duty vehicles to protect the axle from mechanical impact, and also to protect the environment from the rotating wheel axle. A wheel axle housing is commonly not transparent to radar signal transmission and reception. Hence, the radar sensor 120 is optionally arranged to be mounted onto the rotatable wheel axle 110 in connection to an aperture 420 or a radome section 430 formed in a wheel axle housing 410 of the rotatable wheel axle 110. The aperture may be formed as a slot in the housing through which the radar signal can be emitted and also received. A radome section may be formed as a piece of plastic or other permissible material in the wheel axle housing through which the radar signal can be emitted and received.

The radar sensor 120 may be powered by contactless inductive and/or capacitive power transfer arrangement 440 and/or by an electric brush arrangement 450. In an inductive power transfer arrangement, one or more coils are arranged in connection to the radar sensor on the wheel axle and some sort of magnetic field is generated through which the coils move as the wheel axle rotates. Permanent magnets may, for instance, be arranged on the inside of the wheel axle housing in order to provide operating power to the radar sensor 120. Capacitive power transfer is discussed, e.g., by M. Kline, I. Izyumin, B. Boser and S. Sanders, in “Capacitive power transfer for contactless charging,” 2011 Twenty-Sixth Annual IEEE Applied Power Electronics Conference and Exposition (APEC), 2011, pp. 1398-1404. An electric brush arrangement can of course also be used to power the radar sensor on the wheel axle 110. A brush (often a carbon brush) is an electrical contact which conducts current between stationary wires and moving parts, most commonly in a rotating shaft. Typical applications include electric motors, alternators, and electric generators. Such electric brushes are generally known and will therefore not be discussed in more detail herein.

In order to keep dirt away from the transmission lobe of the radar sensor 120, fins can be attached to the wheel axle 110 in order to generate a flow of air in connection to the radar sensor 120.

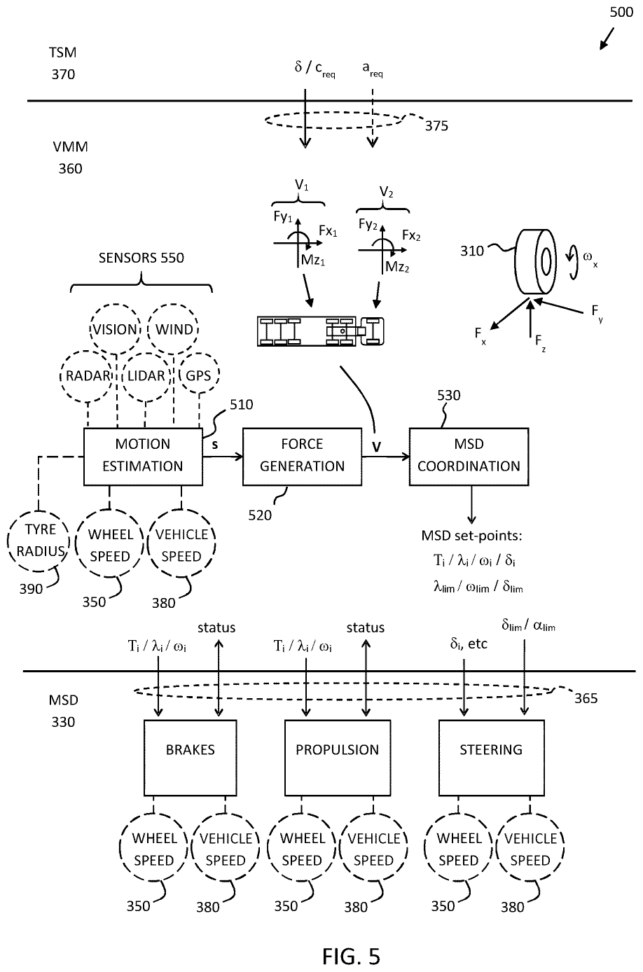

FIG. 5 illustrates an example vehicle control function architecture applicable with the herein disclosed methods, where the TSM function 370 generates vehicle motion requests 375, which may comprise a desired steering angle δ or an equivalent curvature c_{req} to be followed by the vehicle, and which may also comprise desired vehicle unit accelerations areq and also other types of vehicle motion requests, which together describe a desired motion by the vehicle along a desired path at a desired velocity profile.

The VMM system 360 operates with a time horizon of about 1 second or so, and continuously transforms the acceleration profiles a_{req} and curvature profiles c_{req} from the TSM function into control commands for controlling vehicle motion functions, actuated by the different MSDs of the vehicle 100 which report back capabilities to the VMM, which in turn are used as constraints in the vehicle control. The VMM system 360 performs vehicle state or motion estimation 510, i.e., the VMM system 360 continuously determines a vehicle state s comprising positions, speeds, accelerations, and articulation angles of the different units in the vehicle combination by monitoring operations using various sensors 550 arranged on the vehicle 100, often but not always in connection to the MSDs. An important input to the motion estimation 510 may of course be the signals from the radar sensor systems discussed herein, i.e., the vehicle speed sensor data 380, the wheel speed sensor 350 data and the tyre radius data 390 associated with the heavy-duty vehicle 100.

The result of the motion estimation 510, i.e., the estimated vehicle state s, is input to a force generation module 520 which determines the required global forces V=[V₁, V₂] for the different vehicle units to cause the vehicle 100 to move according to the requested acceleration and curvature profiles a_{reg}, c_{reg}, and to behave according to the desired vehicle behavior. The required global force vector V is input to an MSD coordination function 530 which allocates wheel forces and coordinates other MSDs such as steering and suspension. The MSD coordination function outputs an MSD control allocation for the i:th wheel, which may comprise any of a torque Tᵢ, a longitudinal wheel slip λᵢ, a wheel rotational speed ωᵢ, and/or a wheel steering angle δᵢ. The coordinated MSDs then together provide the desired lateral Fy and longitudinal Fx forces on the vehicle units, as well as the required moments Mz, to obtain the desired motion by the vehicle combination 100.

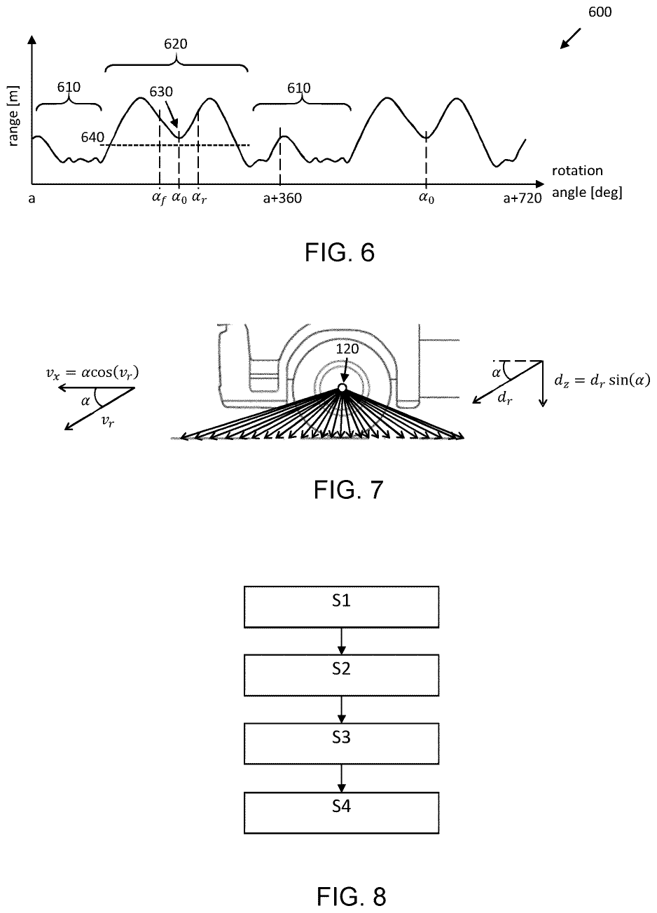

FIG. 6 schematically illustrates how the distance data output from a radar sensor attached to a wheel axle may look as function of angle of rotation of the wheel axle. The distance data exhibits a periodicity as mentioned above, due to the slow time variation in the radio propagation environment of the wheel axle compared to the rotation speed of the wheel axle. The rotation speed of the wheel axle can be determined by frequency analysis of the distance data sequence, e.g., by computing its autocorrelation function in a known manner.

A portion of the distance data sequence 610 represents directions from the wheel axle to parts of the vehicle chassis. This portion does not carry useful information about the loaded tyre radius nor the vehicle speed over ground. Another portion 620 is the angular range where the radar signal impinges on the road surface. The distance data in this region will have a characteristic look, which can be used to detect when the radar transmission is normal to the ground. This is the distance from which the loaded tyre radius R_{L} can be determined. A range threshold 640 can also be used to distinguish the portion 620 from the portion 610, since distances from the axle to ground are normally larger than the distance from the axle to the chassis. According to some aspects, the control system 150 is arranged to determine the distance d_{z} between the wheel axle 110 and the road surface 101 supporting the heavy-duty vehicle 100, normal to the road surface, by identifying a distance corresponding to a local minimum 630 of the distance data sequence, as illustrated in FIG. 6. The control system can then identify measurements with a suitable angle α_{f}, αᵣ for determining speed over ground by adding a positive and/or negative offset to the “normal angle” α₀ which corresponds to a direction normal to the road surface 101. Alternatively, a rotary encoder of some sort can be arranged to output the angular position of the wheel axle to the control system and/or to the radar sensor 120, which would allow a direct determination of the distance measurement in the sequence of distances that corresponds to the direction normal to the road surface. A rotary encoder, also called a shaft encoder, is an electro-mechanical device that converts the angular position or motion of a shaft or axle to analog or digital output signals. There are two main types of rotary encoder: absolute and incremental. The output of an absolute encoder indicates the current shaft position, making it an angle transducer. The output of an incremental encoder provides information about the motion of the shaft, which typically is processed elsewhere into information such as position, speed, and distance. Given the output signal from a rotary encoder arranged in connection to the wheel axle, the control system 150 and/or the radar sensor 120 is able to determine the current angle of the wheel axle and therefore also the current direction of the bore sight of the radar transmission lobe 130. Rotary encoders are generally known and will therefore not be discussed in more detail herein.

Thus, according to some aspects, the radar sensor system comprises a rotational encoder arranged to output an angular position of the wheel axle, and the control system 150 is arranged to receive the angular position of the wheel axle from the rotational encoder, and also to process the distance data sequence based on the angular position of the wheel axle 110.

It is furthermore appreciated that the control system can use all measurements of distance and/or speed over ground collected by the radar sensor during one or more revolutions o the wheel axle 110. FIG. 7 illustrates such a plurality of measurements being obtained as the radar sensor completes one revolution. Each arrow in FIG. 7 represents one measurement opportunity for both distance to ground as well as longitudinal and lateral velocity of the vehicle relative to ground. A suitable transformation has to be applied as function of the angle between the bore sight of the radar transmission lobe 130 and the road surface 101.

The vehicle longitudinal velocity, for instance, is obtained as

$${v}_{x} = α cos ( {v}_{r} )$$

where α the angle between the bore sight of the radar transmission lobe 130 and the road surface 101, and vᵣ is the radial velocity measured by the radar system 120.

The distance d_{z} from the wheel axle 110 to the road surface 101 is obtained as

$${d}_{z} = {d}_{r} sin ( α )$$

where dᵣ is the radial distance detected by the radar sensor 120, and α is again the angle between the bore sight of the radar transmission lobe 130 and the road surface 101.

A weighted combination of the measurements can of course be determined also, making use of all data, but accounting also for that some measurements are more likely to be more accurate than other measurements. Thus, a weighted estimate of the distance d_{z} from the wheel axle 110 to the road surface 101 can be obtained as

$${d}_{z} = {\sum }_{i = 1}^{N} {w}_{i} {d}_{r i} sin ( {α}_{i} )$$

where dᵣᵢ is the i-th radial distance measured at angle αᵢ. The weights wᵢ can be determined from practical experimentation. In this case there are N measurements. It may be suitable to increase the weight as the angle α approaches 90 degrees.

Similarly, the speed over ground vₓ can be determined as

$${v}_{x} = {\sum }_{i = 1}^{N} {w}_{i} {v}_{x i} cos ( {α}_{i} )$$

where vₓᵢ is the i-th radial velocity measured by the radar sensor 120.

To summarize, the control system 150 is according to some aspects arranged to determine the distance d_{z} between the wheel axle 110 and the road surface 101 supporting the heavy-duty vehicle 100, normal to the road surface, based on a weighted combination of elements in the distance data sequence.

According to other aspects, the control system 150 is arranged to determine the longitudinal velocity vₓ and/or the lateral velocity v_{y} of the vehicle 100 relative to the road surface 101 based on a weighted combination of elements in the speed data sequence.

FIG. 8 is a flow chart illustrating a method which summarizes at least some of the discussion above. There is illustrated a method performed by a radar sensor system 160, 200, 210, 400, comprising mounting S1 a radar sensor 120 onto a rotatable wheel axle 110 of a heavy-duty vehicle 100, generating S2 a distance data sequence, by the radar sensor 120, during rotation of the wheel axle 110, receiving S3 the distance data sequence, by a control system 150, and determining S4 a distance d_{z} between the wheel axle 110 and a road surface 101 supporting the heavy-duty vehicle 100, normal to the road surface, based on the distance data sequence.

FIG. 9 is a schematic diagram of a computer system 900 for implementing examples disclosed herein. The computer system 900 is adapted to execute instructions from a computer-readable medium to perform these and/or any of the functions or processing described herein. The computer system 900 may be connected (e.g., networked) to other machines in a LAN, an intranet, an extranet, or the Internet. While only a single device is illustrated, the computer system 900 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, etc., includes reference to one or more such devices to individually or jointly execute a set (or multiple sets) of instructions to perform any one or more of the methodologies discussed herein. For example, control system may include a single control unit, or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 900 may comprise at least one computing device or electronic device capable of including firmware, hardware, and/or executing software instructions to implement the functionality described herein. The computer system 900 may include a processor device 902 (may also be referred to as a control unit), a memory 904, and a system bus 906. The computer system 900 may include at least one computing device having the processor device 902. The system bus 906 provides an interface for system components including, but not limited to, the memory 904 and the processor device 902. The processor device 902 may include any number of hardware components for conducting data or signal processing or for executing computer code stored in memory 904. The processor device 902 (e.g., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein.

The processor device may further include computer executable code that controls operation of the programmable device.

The system bus 906 may be any of several types of bus structures that may further interconnect to a memory bus (with or without a memory controller), a peripheral bus, and/or a local bus using any of a variety of bus architectures. The memory 904 may be one or more devices for storing data and/or computer code for completing or facilitating methods described herein. The memory 904 may include database components, object code components, script components, or other types of information structure for supporting the various activities herein. Any distributed or local memory device may be utilized with the systems and methods of this description. The memory 904 may be communicably connected to the processor device 902 (e.g., via a circuit or any other wired, wireless, or network connection) and may include computer code for executing one or more processes described herein. The memory 904 may include non-volatile memory 908 (e.g., read-only memory (ROM), erasable programmable read-only memory (EPROM), electrically erasable programmable read-only memory (EEPROM), etc.), and volatile memory 910 (e.g., random-access memory (RAM)), or any other medium which can be used to carry or store desired program code in the form of machine-executable instructions or data structures, and which can be accessed by a computer or other machine with a processor device 902. A basic input/output system (BIOS) 912 may be stored in the non-volatile memory 908 and can include the basic routines that help to transfer information between elements within the computer system 900.

The computer system 900 may further include or be coupled to a non-transitory computer-readable storage medium such as the storage device 914, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 914 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 914 and/or in the volatile memory 910, which may include an operating system 916 and/or one or more program modules 918. All or a portion of the examples disclosed herein may be implemented as a computer program product 920 stored on a transitory or non-transitory computer-usable or computer-readable storage medium (e.g., single medium or multiple media), such as the storage device 914, which includes complex programming instructions (e.g., complex computer-readable program code) to cause the processor device 902 to carry out the steps described herein. Thus, the computer-readable program code can comprise software instructions for implementing the functionality of the examples described herein when executed by the processor device 902. The processor device 902 may serve as a controller or control system for the computer system 900 that is to implement the functionality described herein.

The computer system 900 also may include an input device interface 922 (e.g., input device interface and/or output device interface). The input device interface 922 may be configured to receive input and selections to be communicated to the computer system 900 when executing instructions, such as from a keyboard, mouse, touch-sensitive surface, etc. Such input devices may be connected to the processor device 902 through the input device interface 922 coupled to the system bus 906 but can be connected through other interfaces such as a parallel port, an Institute of Electrical and Electronic Engineers (IEEE) 1394 serial port, a Universal Serial Bus (USB) port, an IR interface, and the like. The computer system 900 may include an output device interface 924 configured to forward output, such as to a display, a video display unit (e.g., a liquid crystal display (LCD) or a cathode ray tube (CRT)). The computer system 900 may also include a communications interface 926 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise.

As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A radar sensor system comprising
a radar sensor arranged to be mounted onto a rotatable wheel axle of a heavy-duty vehicle, where the radar sensor is arranged to generate a distance data sequence during rotation of the wheel axle, and
a control system arranged to receive the distance data sequence from the radar sensor and to determine a distance between the wheel axle and a road surface supporting the heavy-duty vehicle, normal to the road surface, based on the distance data sequence.

2. The radar sensor system according to claim 1,
where the control system is arranged to determine a loaded tyre radius and/or an effective rolling radius of a wheel of the heavy-duty vehicle, based on the determined distance between the wheel axle and the road surface.

3. The radar sensor system according to claim 1, comprising at least two radar sensors arranged spatially separated on the rotatable wheel axle,
where the control system is arranged to receive distance data sequences from the spatially separated radar sensors and to determine respective distances-between the wheel axle and the road surface for each radar sensor based on the distance data sequences,
where the control system is arranged to determine a roll motion of the heavy-duty vehicle based on the determined distances.

4. The radar sensor system according to claim 1, comprising at least two radar sensors arranged spatially separated on different rotatable wheel axles,
where the control system is arranged to receive distance data sequences from the radar sensors on the different rotatable wheel axles and to determine respective distances between the wheel axle and the road surface for each radar sensor based on the distance data sequences,
where the control system is arranged to determine a pitch motion of the heavy-duty vehicle based on the determined distances.

5. The radar sensor system according to claim 1,
where the control system is arranged to determine the distance between the wheel axle and the road surface supporting the heavy-duty vehicle, normal to the road surface, by identifying a distance corresponding to a local minimum of the distance data sequence.

6. The radar sensor system according to claim 1,
comprising a rotational encoder arranged to output an angular position of the wheel axle,
where the control system is arranged to receive the angular position of the wheel axle from the rotational encoder, and to process the distance data sequence based on the angular position of the wheel axle.

7. The radar sensor system according to claim 1,
where the control system is arranged to determine the distance between the wheel axle and the road surface supporting the heavy-duty vehicle, normal to the road surface, based on a weighted combination of elements in the distance data sequence.

8. The radar sensor system according to claim 1,
where the radar sensor is arranged to be mounted onto the rotatable wheel axle in connection to an aperture or a radome section formed in a wheel axle housing of the rotatable wheel axle.

9. The radar sensor system according to claim 1,
where the radar sensor is arranged to be powered by an inductive power transfer arrangement and/or a capacitive power transfer arrangement and/or by an electric brush arrangement.

10. The radar sensor system according to claim 1,
where the radar sensor is arranged to transmit the distance data sequence as a wireless signal to a receiver communicatively coupled to the control system.

11. The radar sensor system according to claim 1,
where the radar sensor is arranged to generate a longitudinal speed data sequence during rotation of the wheel axle, and
where the control system is arranged to receive the longitudinal speed data sequence from the radar sensor and to determine a longitudinal velocity of the vehicle relative to the road surface based on the longitudinal speed data sequence.

12. The radar sensor system according to claim 1,
where the radar sensor is arranged to generate a lateral speed data sequence during rotation of the wheel axle, and
where the control system is arranged to receive the lateral speed data sequence from the radar sensor and to determine a lateral velocity of the vehicle relative to the road surface based on the lateral speed data sequence.

13. The radar sensor system according to claim 11,
where the control system is arranged to determine the longitudinal velocity and/or the lateral velocity of the vehicle relative to the road surface based on a weighted combination of elements in the speed data sequence.

14. The radar sensor system according to claim 1, comprising fins attached to the wheel axle configured to generate a flow of air in connection to the radar sensor.

15. The radar sensor system according to claim 1, where the control system is arranged to determine a rotation speed of the wheel axle based on the distance data sequence.

16. The radar sensor system according to claim 1, where the radar sensor is arranged to generate a distance data sequence when the wheel axle is stationary.

17. A heavy-duty vehicle comprising the radar sensor system according to claim 1.

18. A method performed by a radar sensor system, comprising
mounting a radar sensor onto a rotatable wheel axle of a heavy-duty vehicle, generating a distance data sequence, by the radar sensor, during rotation of the wheel axle,
receiving the distance data sequence, by a control system, and
determining a distance between the wheel axle and a road surface supporting the heavy-duty vehicle, normal to the road surface, based on the distance data sequence.
